(19) United States
(12) Patent Application Publication
(10) Pub. No.: US 2002/0176736 A1
(43) Pub. Date: Nov. 28, 2002

(54) Bending and direction-changing structure for big umbrella

(76) Inventor: Chih-Ching Tsou, Taipei (TW)

Correspondence Address: David E. Dougherty, DENNISON, SCHULTZ & DOUGHERTY, 612 Crystal Square 4, 1745 Jefferson Davis Highway, Arlington, VA, 22202, US

(21) Appl. No.: 09/862,299

(22) Filed: May 23, 2001

(51) Int. Cl. F16D 1/12; F16D 3/00; F16C 11/00

(52) U.S. Cl. 403/103

(57) ABSTRACT

A bending and direction-changing structure for a big umbrella comprising an upper sleeve, a lower sleeve and a bending mechanism, the bending mechanism is tightly combined with the upper and the lower sleeves; the bending mechanism is provided with an upper and a lower fixing seat, a plurality of elastic members are provided between the upper and lower fixing seats in cooperating with a locking member to make the upper and lower fixing seats inseparable but rotatable for angular change. The upper and lower fixing seats are provided respectively with bevel surface therebetween to get changing of bending of the shaft of the umbrella. Such structure suits various big umbrellas; the umbrella can thereby have bending angle of its shaft changed for sun shading.

### BACKGROUND OF THE INVENTION

1. Field of the Invention

The present invention is related to a bending and direction-changing structure for a big umbrella, and especially to such a structure in which an upper sleeve and a lower sleeve are respectively tightly connected with a bending mechanism to obtain the effects of convenient operation and bending in multiple directions. Such structure suits big umbrellas or similar articles; the umbrella can thereby have bending angle of its shaft changed.

2. Description of the Prior Art

Since big umbrellas were widely used, sun-shading function of them has been highly thought of, thereby, big umbrellas are produced in large amount in the markets.

However, a positioning device for most bending connectors of big umbrellas is comprised mainly of an upper convex connector, a lower concave connector, a positioning rod, a spring cotter and a spring. The upper convex connector is provided on the flat upper engaging end portion thereof with a positioning flange; the lower concave connector is provided on the inner sides of the top engaging ribs thereof respectively with arciform recesses for engaging and limiting to prevent overly large bending angles, and the bending angles can be predetermined. Thereby, practicality of convenient engaging and positioning in bending can be obtained. However, such a positioning device for bending connectors of big umbrellas can only render the shaft of an umbrella to bend in a plane, direction variations are few, and each time when it is bent, the positioning rod must be pulled out and the upper convex connector has to be supported with one hand; by the fact that the weight of the umbrella supported by the upper convex connector is quite large, an operator is subjected to uneasiness of holding and damaging his hands.

### SUMMARY OF THE INVENTION

The main object of the present invention is to provide a bending and direction-changing structure for a big umbrella of which the shaft is same as a normal one in appearance, while it can provide a specific angular change after relative rotation of an upper and a lower sleeve, operation of it is simple and convenient. It suits sun shading of big umbrellas.

The secondary object of the present invention is to provide a bending and direction-changing structure for a big umbrella by which a user needs only to hold tight the lower sleeve with one hand and to rotate the upper sleeve with another hand, the umbrella can thus be bent easily to effect a change of bending angle of the shaft. Operation of it is simple, and using of it is more convenient.

To get the above stated objects, in the present invention, the lower port of the upper sleeve is tightly connected with an upper fixing seat of a bending mechanism, the upper port of the lower sleeve is tightly connected with a lower fixing seat of the bending mechanism. The bending mechanism is movably combined from the upper and the lower fixing seats. The upper fixing seat has a bottom bevel surface, and the lower fixing seat has a top bevel surface; a plurality of elastic members and a locking member are provided between the top and the bottom bevel surfaces to make the upper and the lower fixing seats inseparable but rotatable for angular change. Therefore, the umbrella can be operated easily and conveniently, and practicality and convenience of it is increased.

The present invention will be apparent in its structure and features after reading the detailed description of the preferred embodiment thereof in reference to the accompanying drawings.

### BRIEF DESCRIPTION OF THE DRAWINGS

FIG. 1 is a perspective view showing the appearance of an embodiment of the present invention;

FIG. 2 is an analytic perspective view showing the elements in the embodiment of the present invention;

FIG. 3a and 3b are respectively schematic sectional views showing the situation before and after bending of the embodiment of the present invention;

FIG. 4 is a schematic perspective view showing bending of the embodiment of the present invention;

FIG. 5 is a schematic view showing using of the embodiment of the present invention;

FIG. 6 is an analytic perspective view showing the elements in another embodiment of the present invention;

FIG. 7a and 7b are respectively schematic sectional views showing the situation before and after bending of the other embodiment of the present invention;

FIG. 8 is a schematic view showing connecting of a sheet member with a positioning pin on the other embodiment of the present invention.

### DETAILED DESCRIPTION OF THE PREFERRED EMBODIMENT

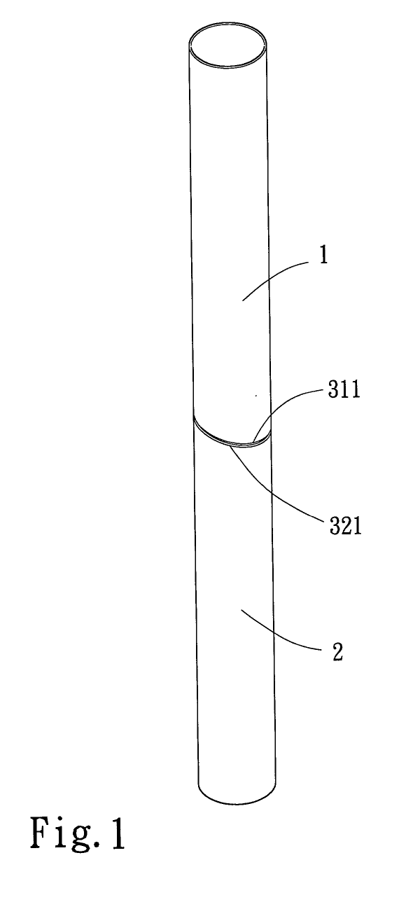

Referring to FIGS. 1, 2 and 3, the bending and direction-changing structure for a big umbrella of the present invention is comprised of an upper sleeve 1, a lower sleeve 2 and a bending mechanism 3.

The upper sleeve 1 is a hollow sleeve, it is provided on the lower port thereof with a bevel rim 11 to be welded to or tightly interference fitted with an upper fixing seat 31 of the bending mechanism 3.

The lower sleeve 2 is a hollow sleeve, it is provided on the upper port thereof with a bevel rim 21 to be welded to or tightly interference fitted with a lower fixing seat 32 of the bending mechanism 3.

The bending mechanism 3 is movably combined from the upper and the lower fixing seats 31, 32. The upper fixing seat 31 is provided with a bevel through hole 313; and is provided on the top thereof with a top bevel surface 314, on the bottom thereof with a bottom bevel surface 311 which has a recessed portion 315 having therein four grooves 312. A sheet member 38 is provided in the recessed portion 315 and is provided with a central through hole 382 and four through holes 381 respectively corresponding by position to the four grooves 312 in the recessed portion 315. The lower fixing seat 32 is provided with a bevel through hole 323; and is provided on the top thereof with a top bevel surface 321, on the bottom thereof with a bottom bevel surface 324. The top bevel surface 321 has four bevel slots 322 corresponding by position to the four grooves 312 in the bottom bevel surface 311.

A plurality of elastic members are provided between the top bevel surface 321 and the bottom bevel surface 311 in correspondence by position with the four grooves 312 and the four bevel slots 322. The elastic members are comprised each of a spring 325 and a steel bead 326, each bevel slot 322 has therein a spring 325 above which is a steel bead 326. The bevel through hole 323 provided in the lower fixing seat 32 is given with a washer 34 at the bottom thereof on the bottom bevel surface 324. A bolt 33 is extended sequentially through the washer 34, the bevel through hole 323 in the lower fixing seat 32, the central through hole 382 on the sheet member 38, the bevel through hole 313 on the upper fixing seat 31, then another washer 36 is put over it and a nut 37 is screwed tight thereon.

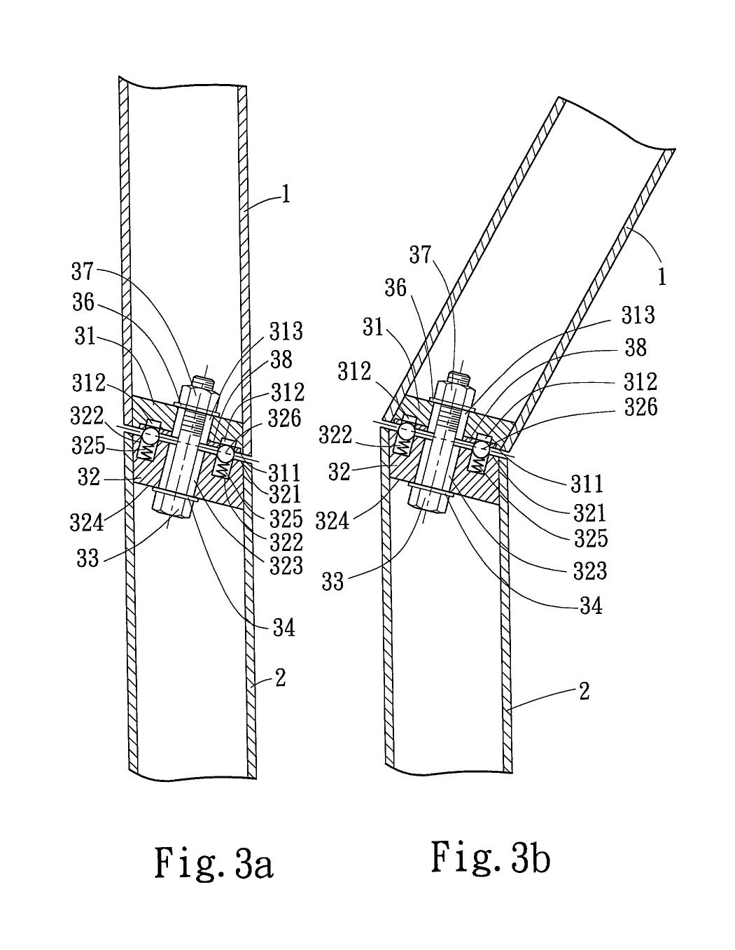

With the above stated members forming the bending and direction-changing structure for a big umbrella, referring to FIG. 3a, 3b and 4, the present invention is characterized by that: with the bending mechanism 3 combined from the upper sleeve 1 and the lower sleeve 2, the big umbrella can be bent in multiple directions. Wherein, with the lower sleeve 2 and the lower fixing seat 32 tightly combined with each other and fixed in stationary state, the upper sleeve 1 is then rotated to make the bottom bevel surface 311 of the upper fixing seat 31 tightly combined with the upper sleeve 1 press down the steel beads 326 during rotation by means of the springs 325 in the grooves 312 and the corresponding bevel slots 322 of the lower fixing seat 32. When the steel beads 326 get in the corresponding bevel slots 322, they can make firm engagement between the upper fixing seat 31 and the lower fixing seat 32 in a bending state by means of the restoring force of the springs 325. In the same way, they can go on to move to get various other bending angles, in order to obscure sunshine in different times, and by extending the bolt 33 sequentially through the washer 34, the bevel through hole 323 in the lower fixing seat 32, the central through hole 382 on the sheet member 38, the bevel through hole 313 on the upper fixing seat 31 and the other washer 36 to be screwed thereon the nut 37 for tight connecting. The present invention can thus get firm combining, and is easier to bend in multiple directions; practicality as well as safety of the bending and direction-changing structure of the big umbrella can thus be increased.

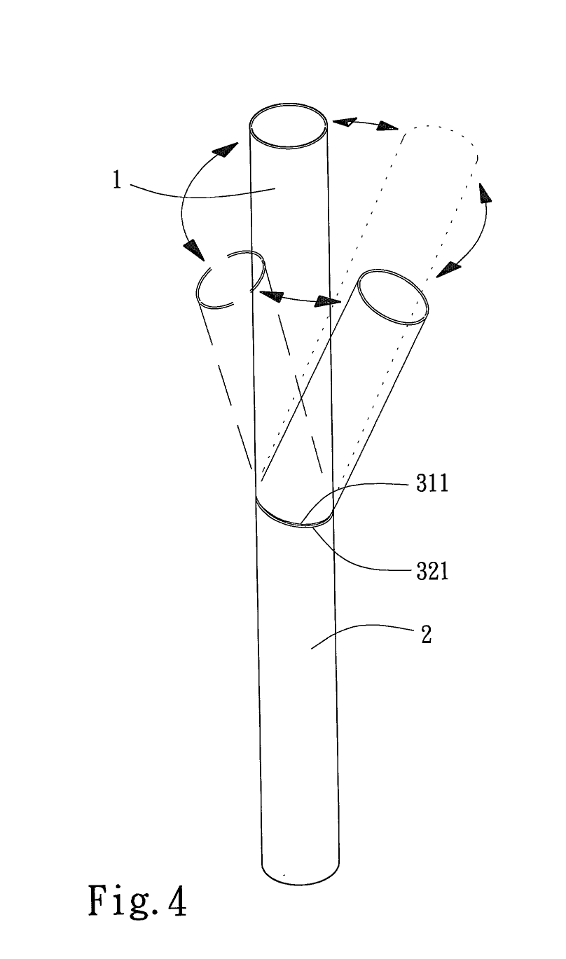

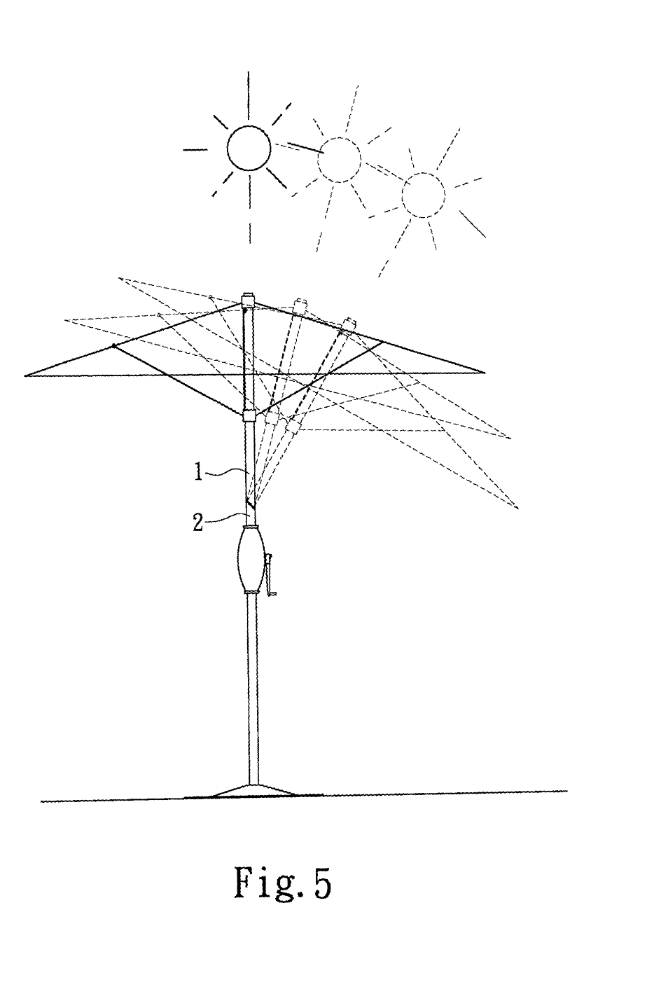

Referring to FIGS. 4 and 5, when in use, and the upper sleeve 1, the lower sleeve 2 and the bending mechanism 3 are combined with one another, the upper sleeve 1 is rotated to make the bending mechanism 3 have various probable bending angles in order to obscure sunshine in different incident angles in different times, bending thereof can be easier and can be done in multiple directions, thus practicality as well as convenience of operation can be increased.

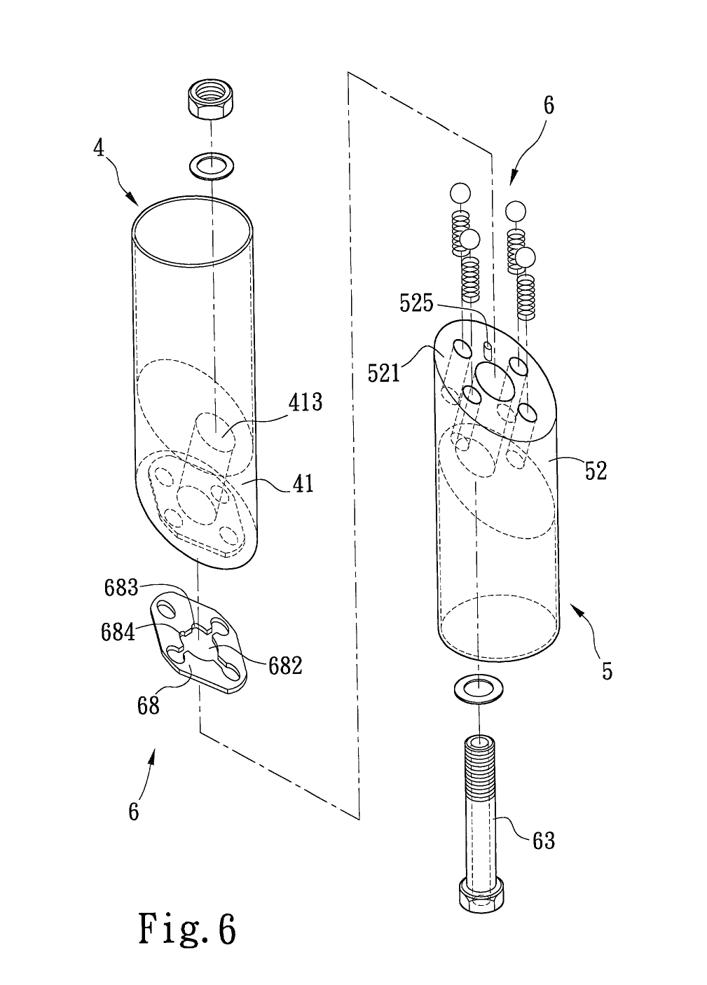

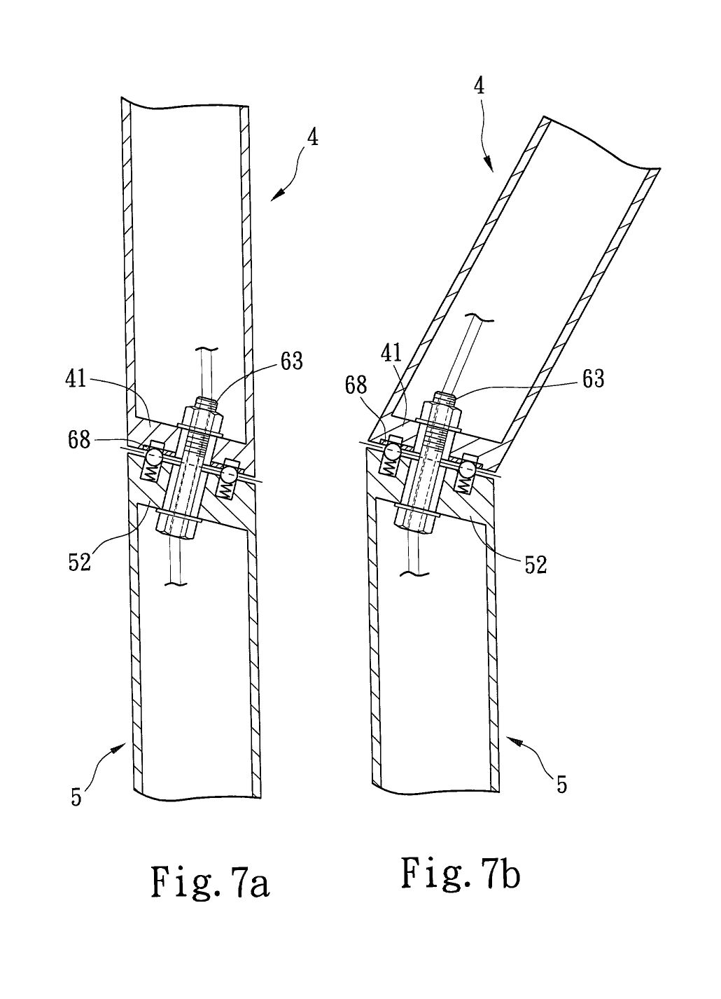

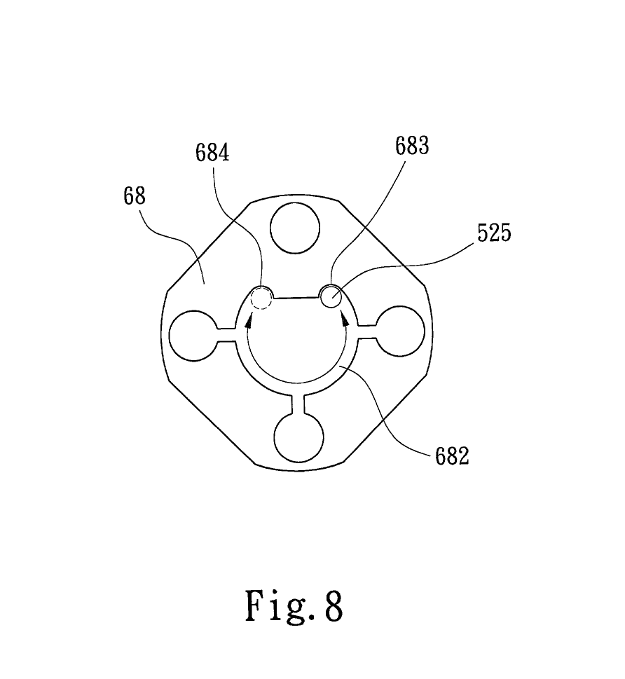

Referring to FIGS. 6-8, under the same conception as stated above, the present invention can also be provided integrally in the upper sleeve and the lower sleeve with an upper and a lower fixing portion in lieu of the mutual separated upper and lower fixing seats, in this different embodiment, the present invention is comprised of an upper sleeve 4, a lower sleeve 5 and a bending mechanism 6. The bending mechanism 6 is combined between the upper sleeve 4 and the lower sleeve 5. The upper sleeve 4 is hollow on the upper end thereof, it is provided on the lower end thereof with an upper fixing portion 41. The lower sleeve 5 is hollow on the lower end thereof, and is provided on the upper end thereof with a lower fixing portion 52. The most different points of the bending mechanism 6 from the former embodiment are that, a top bevel surface 521 of the lower fixing portion 52 has a positioning pin 525 thereon; and a sheet member 68 with a central through hole 682 therein is provided, the central through hole 682 is further provided with two positioning recesses 683, 684 for the purpose that the positioning pin 525 after assembling can slide and positioned between the two positioning recesses 683, 684 provided on the rim of the through hole 682 in the sheet member 68 (as shown in FIG. 8). In this way, rotation of the upper sleeve 4 is limited to 270 degrees (thereby when in use, a rope extending through the hollow bolt 63 will not be tangled by rotation) rather than being able of rotating in 360 degrees (which can render the rope to be twisted and tangled by accumulative rotation in the obscured pipe-like sleeves); and the bolt 63 provided for locking the bending mechanism 6 is hollow. Thus operation can be simple and convenient, and bending in multiple directions can be effected.

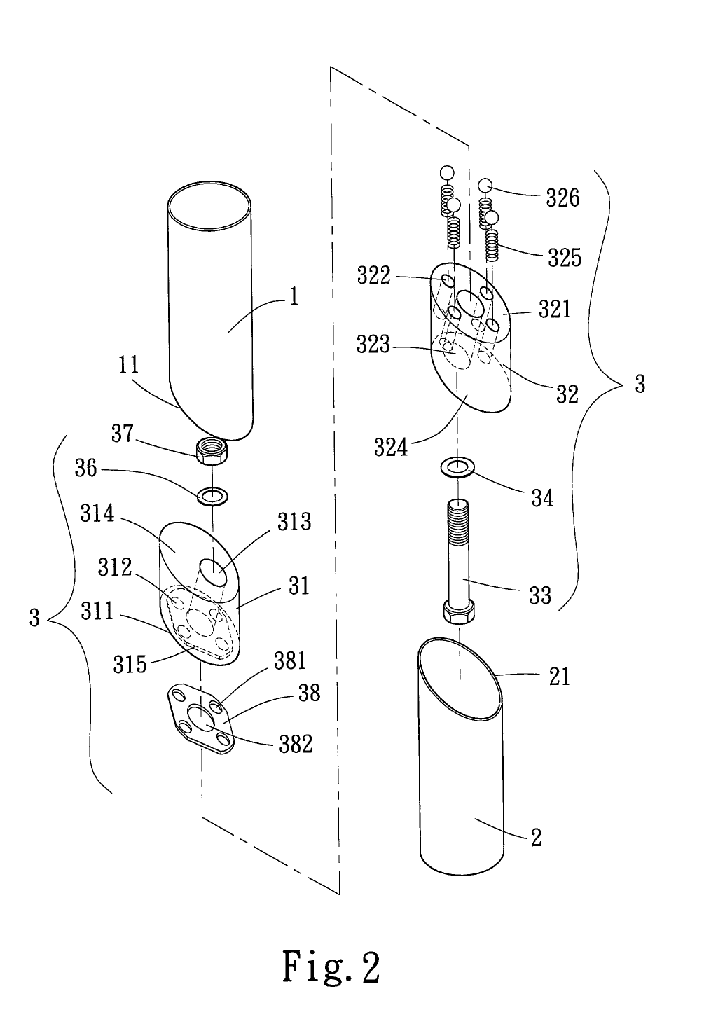

Although the embodiment of the bending mechanism shown in FIG. 2 has four grooves on the top bevel surface of the lower fixing seat, and elastic members in corresponding amount are provided, practically, it is adequate to provide at least one groove with a corresponding amount of elastic members, the upper and lower fixing seats can get the object of relative rotating and elastic engagement.

Therefore, the present invention has the following advantages:

1. By movable combining of the upper and lower sleeves with the bending mechanism, an effect of bending in multiple directions can be achieved.

2. With the present invention, it needs only to hold the lower sleeve tightly with a hand, and rotate the upper sleeve with another hand, the big umbrella can be easily bent, operation of it is simple, and using of it is more convenient.

In conclusion, the present invention can not only get rid of the defects resided in the bending mechanism of a conventional big umbrella, but also can get the effects of convenient operation and bending in multiple directions, practicality and convenience of use of the present invention can be increased, and the present invention can suit various big umbrellas.

1. A bending and direction-changing structure for a big umbrella comprising an upper sleeve, a lower sleeve and a bending mechanism, said upper sleeve and said lower sleeve are respectively combined with said bending mechanism, said structure is characterized by that:
said upper sleeve is a hollow sleeve, and is tightly combined on a lower port thereof with an upper fixing seat of said bending mechanism;
said lower sleeve is a hollow sleeve, and is tightly combined on an upper port thereof with a lower fixing seat of said bending mechanism;
said bending mechanism is movably combined from said upper and lower fixing seats, said upper fixing seat is provided on the bottom thereof with a bottom bevel surface, a plurality of elastic members and a locking member are provided to make said upper and lower fixing seats inseparable but rotatable for angular change, said umbrella thus is adapted to being operated easily and conveniently, and being bent in multiple directions.

2. A bending and direction-changing structure for a big umbrella as in claim 1, wherein:
said upper fixing seat in said bending mechanism is provided with a central bevel through hole; and is provided on said bottom bevel surface thereof with a plurality of grooves.

3. A bending and direction-changing structure for a big umbrella as in claim 1, wherein:
said lower fixing seat in said bending mechanism is provided with a central bevel through hole, and is provided on said top bevel surface thereof at least with a groove.

4. A bending and direction-changing structure for a big umbrella as in claim 1, wherein:
said elastic members of said bending mechanism are comprised at least of a spring and a steel bead, said elastic members are provided in said grooves on said top bevel surface of said lower fixing seat, and are provided thereon with said steel beads in order that said upper and lower fixing seats are adapted to relative rotating and mutual elastic engagement.

5. A bending and direction-changing structure for a big umbrella as in claim 1, wherein:
said upper fixing seat of said bending mechanism is provided on said bottom bevel surface thereof with a recessed portion, a sheet member is provided in said recessed portion and is provided centrally thereof with a through hole and other through holes respectively corresponding by position to said grooves in said recessed portion in favor of positioning of steel beads held on said elastic members.

6. A bending and direction-changing structure for a big umbrella as in claim 1, wherein:
said locking member of said bending mechanism is comprised of a bolt and a nut, and is locked by extending said bolt through bevel through holes centrally provided respectively in said upper and lower fixing seats to be screwed thereon with a nut.

7. A bending and direction-changing structure for a big umbrella as in claim 1, wherein:
said upper and lower sleeves are respectively welded and tightly connected to said upper and lower fixing seats of said bending mechanism.

8. A bending and direction-changing structure for a big umbrella as in claim 1, wherein:
said upper and lower sleeves are respectively interference fitted with and tightly connected to said upper and lower fixing seats of said bending mechanism.

9. A bending and direction-changing structure for a big umbrella comprising an upper sleeve, a lower sleeve and a bending mechanism, said upper sleeve and said lower sleeve are respectively combined with said bending mechanism, said structure is characterized by that:
said upper sleeve is hollow on the upper end thereof, it is provided on the lower end thereof with an upper fixing portion;
said lower sleeve is hollow on the lower end thereof, and is provided on the upper end thereof with a lower fixing portion;
said bending mechanism is movably combined from said upper fixing portion of said upper fixing seat and said lower fixing portion of said lower fixing seat, said upper fixing portion is provided on the bottom thereof with a bottom bevel surface, and said lower fixing portion is provided on the top thereof with a top bevel surface; a plurality of elastic members and a locking member are provided between said top bevel surface and said bottom bevel surface to make said upper and lower fixing seats inseparable but rotatable for angular change, said umbrella thus is adapted to being operated easily and conveniently, and being bent in multiple directions.

10. A bending and direction-changing structure for a big umbrella as in claim 9, wherein:
said locking member of said bending mechanism is comprised of a bolt and a nut, and is locked by extending said bolt through bevel through holes centrally provided respectively in said upper and lower fixing portions to be screwed thereon with a nut.

11. A bending and direction-changing structure for a big umbrella as in claim 10, wherein:
said bolt is hollow.

12. A bending and direction-changing structure for a big umbrella as in claim 9, wherein:
said upper fixing portion of said upper sleeve is provided on said bottom bevel surface thereof with a recessed portion, a sheet member is provided in said recessed portion and is provided centrally thereof with a through hole, said central through hole is further provided with two positioning recesses, said sheet member has other through holes respectively corresponding by position to said two positioning recesses in said recessed portion in favor of positioning of steel beads held on said elastic members.

13. A bending and direction-changing structure for a big umbrella as in claim 9, wherein:
said top bevel surface on said lower fixing portion has a positioning pin thereon, said positioning pin after assembling is adapted to sliding and positioning between said two positioning recesses provided in said sheet member for rotation and positioning of said upper and lower sleeves.
